(19) United States
(12) Patent Application Publication
(10) Pub. No.: US 2005/0074059 A1
(43) Pub. Date: Apr. 7, 2005

(54) Coding images

(75) Inventors: Frederik Jan De Bruijn, Eindhoven (NL); Wilhelmus Hendrikus Alfonsus Bruls, Eindhoven (NL); Gerard De Haan, Eindhoven (NL)

Correspondence Address: U S Philips Corporation;Intellectual Property Department, Post Office Box 3001, Briarcliff Manor, NY, 10510, US

(73) Assignee: Koninklijke Philips Electronics N.V., Eindhoven (NL)

(21) Appl. No.: 10/498,957

(22) PCT Filed: Nov. 26, 2002
(86) PCT No.: PCT/IB02/05018

(30) Foreign Application Priority Data
Dec. 21, 2001 (EP) 01205132.2

(51) Int. Cl. H04B 1/66

(52) U.S. Cl. 375/240

(57) ABSTRACT

An image encoder with a encoder input; a memory device to said encoder input, for storing a image received at said input; a image predictor device for predicting a prediction image based on a first image stored in said memory device; a combiner device for determining residual data relating to a difference between an original image and the prediction image; a first evaluator for determining a first characteristic; an inhibiter connected to said combiner device and said first evaluator device, for transmitting said residual data further if said first characteristic checks against said first predetermined criterion; and a encoder output connected to said inhibiter device. The image encoder has a second evaluator device for determining a second characteristic, and said inhibiter device is arranged for transmitting said residual data further depending on said first characteristic and said second characteristic.

The invention relates to an image encoder according to the introductory part of claim 1.

In the art of predictive image encoding, such encoders are generally known. Motion-compensated video compression generally requires the transmission of residual information to correct the motion-compensated prediction. The residual information may be based on a pixelwise difference between an original frame and a prediction frame.

However, the known encoders are disadvantageous because in case of an erroneous estimate, the amount residual data particularly tends to increase in detailed areas and hence the amount of outputted data tends to be large.

It is therefore a goal of the invention to provide an encoder with a smaller amount of outputted data. In order to achieve this goal, according to the invention, an encoder device as described is characterized in that said image encoder further comprises: a second evaluator device for determining at least one second characteristic, and said inhibiter device is arranged for transmitting said residual data further depending on said first characteristic and said second characteristic.

The amount of outputted data is reduced because the residual data is transmitted depending on the first and second characteristic. Furthermore, if the first characteristic relates to the difference between the original image and the predicted image and the second characteristic corresponds to changes of elements in the original image compared to the first image, the amount of outputted data is reduced without perceived loss of image quality, because if the change of elements is spatially (and temporally) consistent, small errors in the prediction are not perceived.

The invention further relates to a coding method according to claim 15. As a result of such a method, less data is outputted.

The invention further relates to devices according to claims 16-18, incorporating an image encoder device according to the invention. Also, the invention relates to a coding system according to claim 19, a data container device according to claim 20, a computer program according to claim 21, a data carrier device according to claim 22 and a signal stream according to claim 23. Such devices, systems and program output less data.

Specific embodiments of the invention are set forth in the dependent claims.

Further details, aspects and embodiments of the invention will be described with reference to the attached drawing.

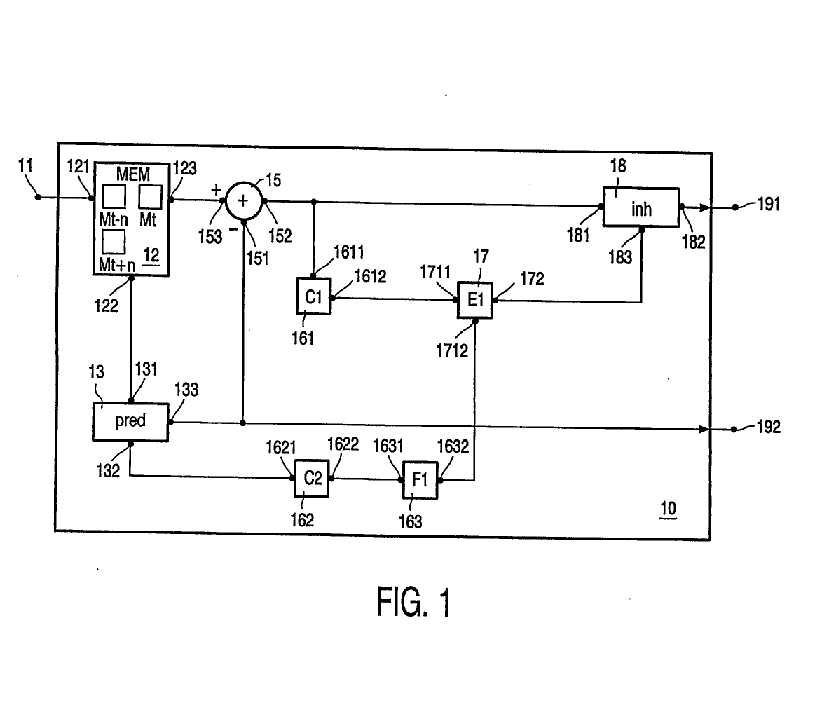

FIG. 1 shows a block diagram of a first example of an embodiment of a device according to the invention.

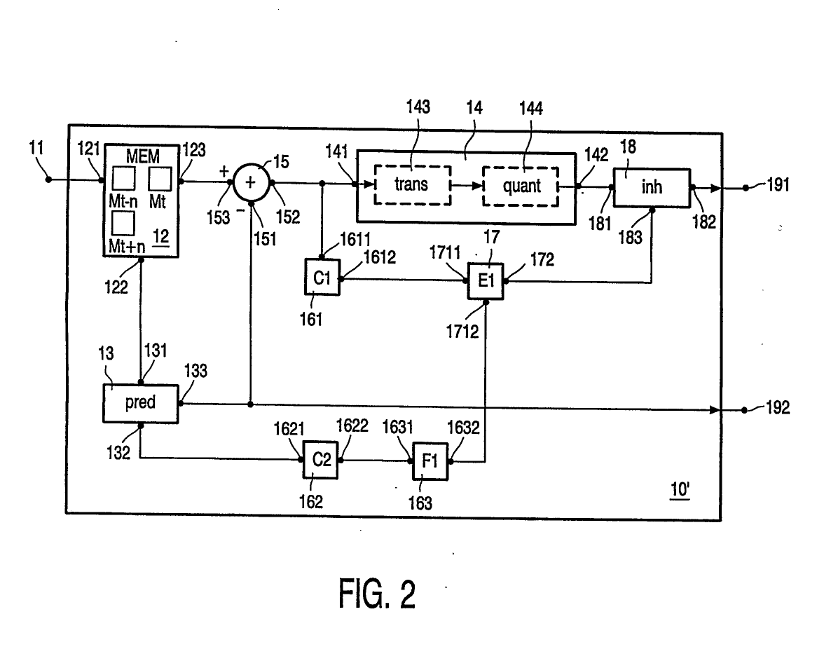

FIG. 2 shows a block diagram of a second example of a device according to the invention.

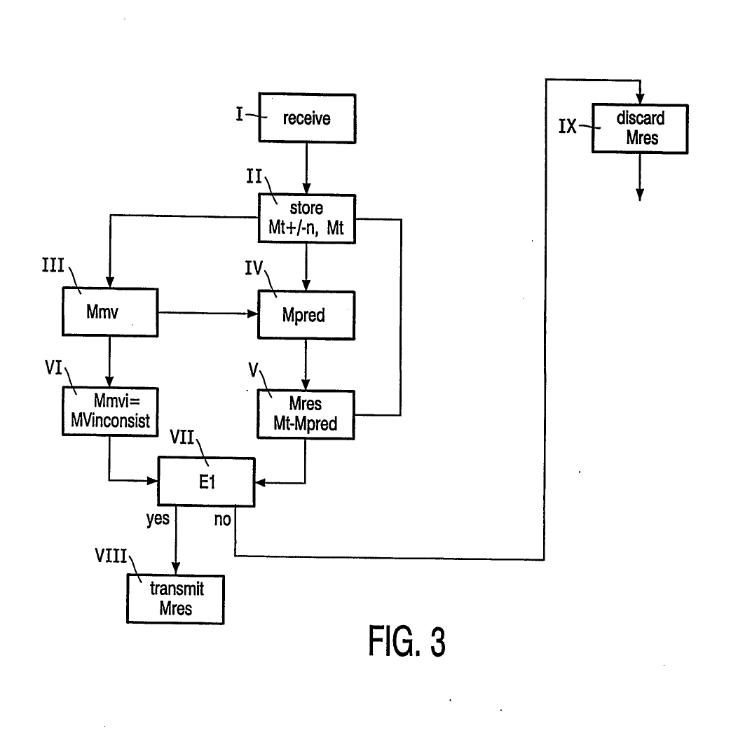

FIG. 3 shows a flow-chart of a first example of a method according to the invention.

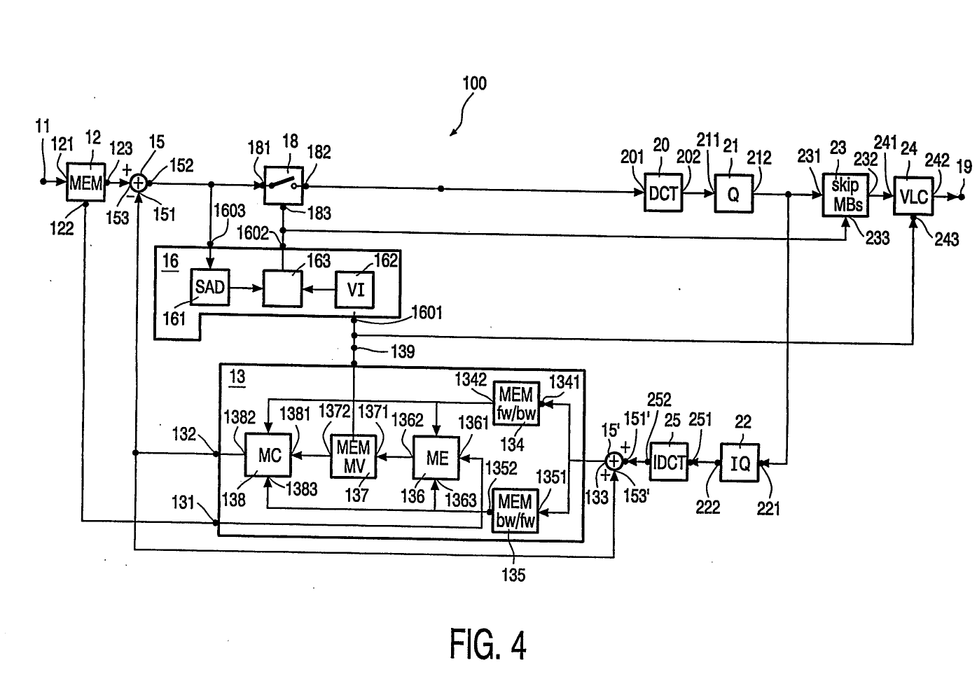

FIG. 4 shows a block diagram of an MPEG encoder comprising an example of an embodiment of a device according to the invention.

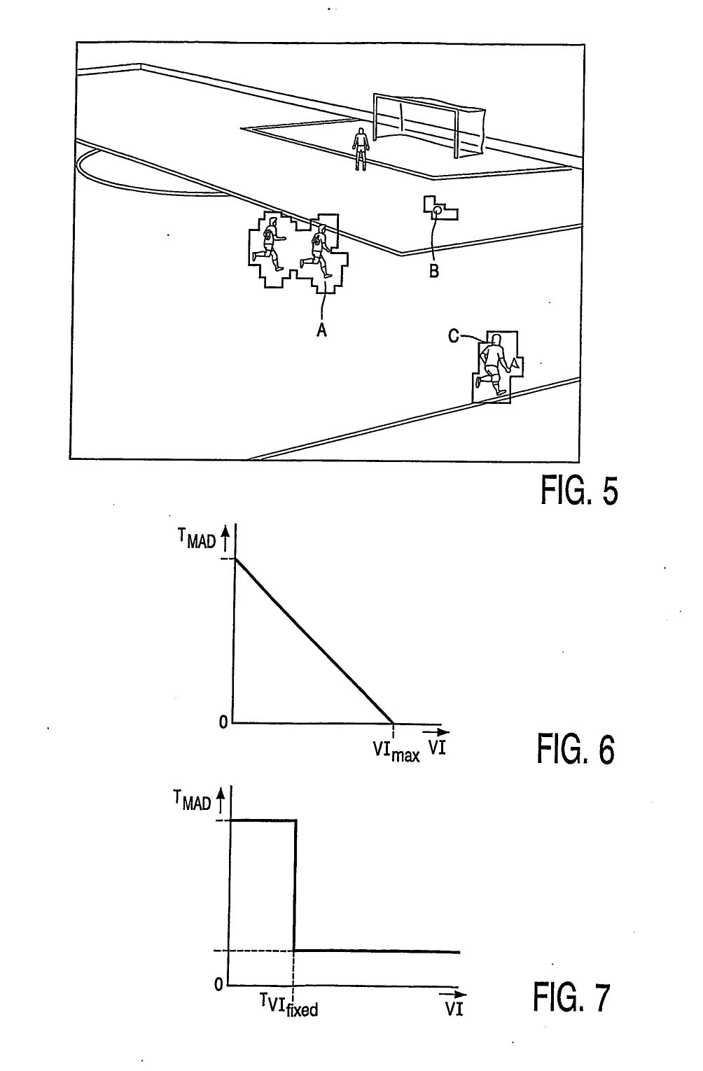

FIG. 5 shows an exemplary image.

FIGS. 6,7 illustrate ways to express the threshold value as a function of the vector inconsistency.

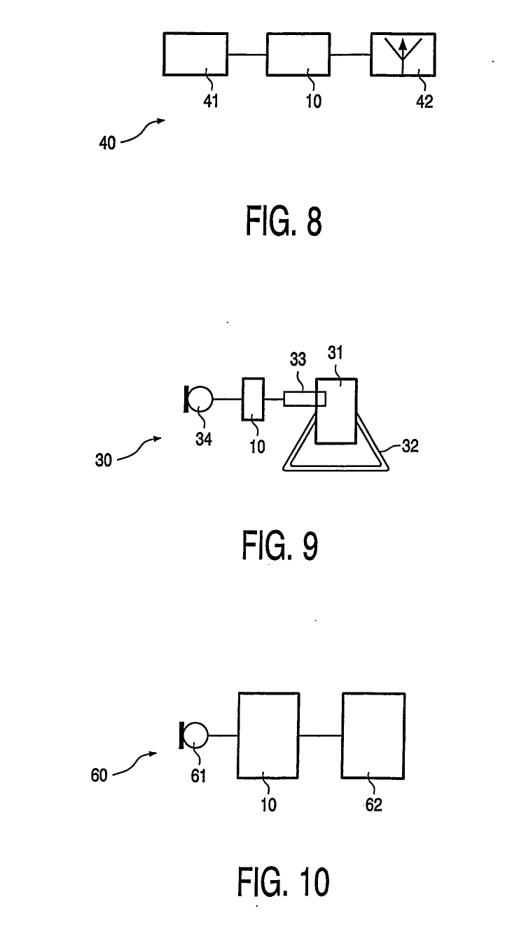

FIG. 8 diagrammatically shows a data transmission device provided with a prediction coder device according to the invention.

FIG. 9 diagrammatically shows a data storage device provided with a prediction coder device according to the invention.

FIG. 10 diagrammatically shows an audio-visual recorder device provided with a prediction decoder device according to the invention.

FIG. 1 shows a block diagram of an example of an embodiment of an encoder device 10 according to the invention. The encoder device 10 has an encoder input 11 connected to an memory input 121 of a memory or buffer device 12. The memory or buffer device 12 is attached with a first memory output 122 to an predictor input 131 of an image predictor device 13 and with a second memory output 123 to a second input 153 of a combiner device 15. The predictor device 13 is connected with a first predictor output 133 to a first combiner input 151 of the combiner device 15. A combiner output 152 of the combiner device 15 is attached to an inhibiter input 181 of an inhibiter device 18 and a first characteriser input 1611 of a first characteriser device 161. The predictor device 13 is further connected via a first predictor output 132 to a second characteriser input 1621 of a second characteriser device 162. A second predictor output 133 is connected to a second encoder output 192. The characteriser device 161 is connected with an output 1612 to an input 1711 of an evaluator device 17. A characteriser output 1622 of the second characteriser device 162 is connected to an input 1631 of a threshold determiner device 163. An output 1632 of the device 163 is connected to a second input 1712 of the AND device 17. The evaluator device 17 is attached with an output 172 to a control input 183 of the inhibiter device 18. An output of the inhibiter device 18 is linked a first encoder output 191.

In use, signals may be received at the encoder input 11 representing two dimensional matrices, e.g. images or frames. Received images are stored in the memory device 12. In this example, an image Mₜ, a preceding image Mₜ₋₁, and a succeeding image Mₜ₊₁ are stored in the memory device 12. The words image, frame and matrix are used interchangeably in this application.

The predictor device 13 may predict a predicted image based on the frames stored in the memory 12. In the example, the predictor device 13 may predict a predicted image M_{pred} of the image Mₜ based on the preceding frame Mₜ₋₁ and the frame image Mₜ₊₁. After prediction, the predicted image M_{pred} is transmitted via the predictor output 132 to the combiner input 151, the second evaluator 16 and the second encoder output 192. The image Mₜ is also transmitted to the combiner device 15 from the memory 12.

The combiner device 15 obtains residual data or error data from the current image and the predicted image. The residual data contains information about the differences between the predicted image and the current image. The combiner device 15 outputs the error data to the inhibiter 18 and the first characteriser device 161. Based on the residual data a first characteristic is determined by the first device 161. The first characteristic is compared with a first criterion by the evaluator device 17.

The predicted image M_{pred} is also transmitted by the predictor device 13 to the second encoder output characteriser. The predictor 13 outputs vector data relating to changes of elements in the current image with respect to preceding or succeeding images to the second characteriser 162. The second evaluator device 162 determines a second characteristic of the predicted image M_{pred}. In this example, the second characteristic corresponds to the changes of elements in the current or original image Mₜ compared to the images the prediction image M_{pred} is determined from, e.g. the preceding image Mₜ₋₁, and the succeeding image Mₜ₊₁. The second characteristic is transmitted to the evaluator 17 which checks the second characteristic against a second criterion.

The evaluator device 17 compares the signals from the devices 161,162 and outputs a binary one signal if both characteristics 161,162 satisfy their criterion. Otherwise, a binary zero is outputted by device 17.

The signal from the evaluator device 17 controls the inhibiter device 18. The inhibiter device 18 prevents the residual data to be transmitted further, i.e. the inhibiter discards the residual data, if at the control port 183 a binary one signal is presented. If the signal at the control port 183 is a binary zero, the inhibiter 18 allows the residual data to be transmitted further to the first encoder output 191.

Thus, the residual data is only transmitted if both the first characteristic and the second characteristic comply with the respective predetermined condition. Thereby, the amount of data outputted by the encoder device 10 is reduced. Furthermore, it is found that errors in the prediction image, due an erroneous estimate in the change of errors, are not perceived by a person viewing the images as long as the local variation of the change of elements is relatively small. When the local variation in the change of elements is relatively large, the change of elements is said to be locally inconsistent. The value of the second characteristic is proportional to this local inconsistency of the change of elements. Hence, the amount of data transmitted by the encoder is reduced without perceived loss in the image of video quality.

FIG. 2 shows a second example of an image encoder 10′ according to the invention. Besides the devices of the encoder of FIG. 1, the encoder 10′ has a data processing device 14. The device 14 is connected with an input 141 to the combiner output 152. An output 142 of the device 14 is connected to the inhibiter input. The device 14 may perform data processing operations, such as quantising the residual data, with a quantiser 144 or transforming the data, for instance from the time domain to the frequency domain with transformer 143.

FIG. 3 shows a flow-chart of an example of a prediction coding method according to the invention. In a reception step I, images are received. In a storage step II, the received images M_{t±n}, Mₜ are stored in a buffer. In a vectorising step III, changes of elements in the current image with respect to an other image are determined. In step IV, the consistency of these changes is determined, which forms a second characteristic. In a prediction step IV, a prediction image M_{pred} is made of an image Mₜ based on at least one image M_{t±n} stored in the buffer and the changes of the elements. The images M_{t±n} may be preceding the image Mₜ, succeeding the image Mₜ or a combination of preceding and succeeding matrices. The predicted image M_{pred} is combined with the image Mₜ in a combining step V. As a result of the combining step residual data Mᵣₑₛ is obtained. In an evaluation step VI, the residual data is evaluated and checked against a first predetermined criterion. Second characteristic is also evaluated and checked against a second predetermined criterion in the evaluation step VII. If both criterions are satisfied, the residual data is transmitted further in step VIII, else the residual data is discarded in step IX.

The residual data may be determined in any manner appropriate for the specific implementation. The residual data may for example be the pixelwise difference between the original image Mₜ and the estimated image M_{pred}, as is for example used in video compression applications, and may mathematically be defined as:
R(x, y, t)=Iₑₛₜ(x, y, t)−I_{orig}(x, y, t), (1)
where R(x,y,t) represents the residual data, Iₑₛₜ (x,y,t) the estimated pixel intensity and I_{orig}(x,y, t) the original pixel intensity at matrix position x, y in an image at time instance t.

In the evaluation of the residual data a value may be determined from the error or residual data, for example the mean squared error (MSE) the mean absolute difference (MAD) or the Sum of Absolute Differences (SAD) may be used. The first evaluator device 161 may for example determine the MAD, the MSE or the SAD and compare this with a predetermined threshold value T. By way of example, the functioning of the evaluator device will be described using the MAD, however other measures may be used instead b the evaluator device.

The MAD may be mathematically defined as

$$MAD ( x , y , t ) = \frac{1}{NM} {\sum }_{ξ = 1}^{N} {\sum }_{γ = 1}^{M} \vert R ( x + ξ , y + γ , t ) \vert \qquad ( 2 )$$

In this equation (2), R represents the residual defined in equation (1), and where N and M denote the width and height respectively of the spatial area evaluated in the calculation. The SAD may mathematically be described as the product N·M·MAD, or:

$$SAD ( x , y , t ) = {\sum }_{ξ = 1}^{N} {\sum }_{γ = 1}^{M} \vert R ( x + ξ , y + γ , t ) \vert \qquad ( {2}^{′} )$$

As a first predetermined criterion used in the evaluation of the residual data. the MAD value may be thresholded. As a result of the thresholding a signal representing a binary one value is returned if the local MAD has exceeded a perceptible magnitude, mathematically described:

$${S}_{MAD} ( x , y , t ) = \{ \begin{matrix}1 & MAD ( x , y , t ) > {T}_{MAD} \\ 0 & otherwise\end{matrix} \qquad ( 3 )$$

As a measure of the movement of elements in the image, the local spatial and/or temporal consistency of motion vectors may be used. The motion vectors may be estimated by the predictor device or the evaluator device, as is generally known in the art of image encoding, for example from the Motion Picture Expert Group (MPEG) compression standard. In the example image of FIG. 5, the areas A-C (e.g. soccer players, ball, etc.) indicate areas where motion occurs and consequently non-zero motion vectors are estimated. The vector inconsistency VI may mathematically be expressed as

$$VI ( x , y , t ) = \frac{1}{( 2 N + 1 ) ( 2 M + 1 ) ( P + 1 )} \\ {\sum }_{ξ = 1}^{N} {\sum }_{γ = 1}^{M} {\sum }_{τ}^{P} \vert \vec{D} ( x , y , t ) - \vec{D} ( x + ξ , y + γ , t - τ ) \vert , \qquad ( 4 )$$

where \vec{D} represents a 2-dimensional motion vector that describes the displacement of elements between two consecutive frames, N and M respectively represent the horizontal and vertical dimension of the spatial area of evaluation, and where P is the number of previous vector fields.

As a second predetermined criterion, the vector inconsistency values may be thresholded. A signal representing a binary one is then returned if the vector inconsistency VI has exceeded a perceptible magnitude.

$${S}_{VI} ( x , y , t ) = \{ \begin{matrix}1 & VI ( x , y , t ) > {T}_{VI} \\ 0 & otherwise\end{matrix} \qquad ( 5 )$$

Errors (i.e. S_{MAD}=1) are only perceived by a viewer if the motion vectors are locally inconsistent. Thus, as a inhibiting criterion it may be demanded that both the MAD and the VI must be above the respective threshold, i.e. S_{MAD} and S_{VI} have a value of one. In a mathematical way this condition may be described as:
S_{perceived}(x,y,t)=S_{MAD}(x,y,t)\hat{ }S_{VI}(x,y,t), (6)
where ‘\hat{ }’ denotes the Boolean ‘AND’ operation.

In the resulting selection only in areas of a strong motion-vector inconsistency (e.g. soccer players and ball, see also FIG. 5, areas A-C) the MAD errors are identified as being perceivable. The MAD errors in the audience in the upper part of the frame of FIG. 5 are caused by an erroneous but consistent motion compensation in which the small deviation from the true motion are not perceived. Possible alternative criteria can be obtained by any other linear or non-linear combination of the MAD and the vector inconsistency values. For example, the local speed may be included as an additional parameter.

If as a measure of the vector inconsistency the definition of equation (4) is used, a short edge in the vector field may give rise to a low VI-value. Consequently, a spatially small disturbance (or edge) in the vector field may stay undetected, whereas the errors due to spatially small inconsistencies are generally easily perceived.

An alternative way to describe the temporal consistency of the motion vectors is not to determine the mean absolute vector difference but maximum absolute vector difference instead,

$$VI ( x , y , t ) = {max}_{- N \leq ξ \leq N ⋀ - M \leq γ \leq M ⋀ 0 \leq r \leq P} \\ \vert \vec{D} ( x , y , t ) - \vec{D} ( x + ξ , y + γ , t - τ ) \vert \qquad ( 7 )$$

The vector consistency calculated with equation (7) treats all the vector differences within the ‘kernel’ range equally important, disregarding the number of vector elements that contribute to the difference. The vector-inconsistency calculated according to equation (7) tends to contain broad regions of high VI-values around a disturbance (or edge). The spatial (temporal) dimensions of the area of the high VI-value is determined by the kernel-size parameters N, M, and P.

The first criterion may be related to the second characteristic or the second criterion. For example, the threshold for the MAD may be related to the vector inconsistency. For example, if the vector inconsistency is determined using expression (7) instead of equation (4), the MAD values may be thresholded using the vector inconsistency values,
T_{MAD}(x,y,t)=α(VIₘₐₓ−VI(x,y,t)) (8)
with α being a positive multiplication factor, and VIₘₐₓ=2|\vec{D}|ₘₐₓ being the maximum of possible VI-values. The threshold Tₘₐₓ is inversely proportional to the vector inconsistency VI. FIG. 6 shows the threshold as a function of the vector inconsistency as described by equation (8). The relation between the threshold T_{MAD} and the vector inconsistency VI does not need to linear. In general, the function T_{MAD}(VI) may be any non-ascending function, and may be implemented as a analytical function or a look-up table.

The behavior of a fixed threshold, i.e. the use of equations (3) and (5) may be achieved using the function depicted in FIG. 7. T_{MAD}(fixed) is the value T_{MAD} in equation (3), T_{VI}(fixed) is the value T_{VI} in expression (₅). If VI>T_{VI}(fixed) and MAD>T_{MAD}(fixed), the residual data is omitted.

Both the residual data and the movement of elements in the image may be determined and evaluated on a block basis, as is for example known from MPEG compliant image encoding. The invention may be applied in a method or device according to an existing video compression standard. Existing video compression standards such as MPEG-2are commonly based on motion-compensated prediction to exploit temporal correlation between consecutive images or frames, see e.g. [1,2].

In MPEG, decoded frames are created blockwise from motion-compensated data blocks obtained from previously transmitted frames. The motion-compensated predictions may be based either on the previous frame in viewing order, or both on the previous and the next frame in viewing order. The unidirectional predictions and the bi-directional predictions are referred to as P-frames and B-frames respectively. The use of B-frames requires temporal rearrangement (shuffling) of the frames such that the transmission order will not be equal anymore to the viewing order. The residual data may outputted by the encoder to correct for errors in the motion-compensated prediction, both for the P- and B-frames.

FIG. 4 shows an example of an image encoder device 100 compliant with the Motion Pictures Expert Group 2 (MPEG-2) standard. The image encoder device is referred to as the MPEG-encoder device 100 from this point on. In the shown encoder device 100 B-frames are predicted. However, I- or P-frames may be used instead.

The MPEG encoder device 100 has an encoder input 11 for the reception of video images. Connected to the encoder input 11 is a memory input 121 of a memory device 12. The memory device 12 has a first memory output 122 connected to a first predictor input 131 of a predictor device 13. A first output 132 of the predictor device 13 is connected to a first input 151 of a first combiner device 15. A second memory output 123 is connected to a second combiner input 153 of a first combiner device 15. A combiner output 152 is connected to a switch input 181 of a switch 18. A switch output 182 is connected to a discrete cosine transformer device (DCT) 20 via a DCT input 201. A DCT output 202 of the DCT 20 is connected to an quantiser input 211 of a quantiser device 21. The quantiser device 21 is attached with a quantiser output 212 to an input 231 of a skip device 23. The skip device 23 is connected to a variable length coder device (VLC) 24 via a skip output 232 and a VLC input 241. An output of the VLC 24 is attached to an encoder output 19.

The quantiser device 21 is also attached with the quantiser output 212 to an inverse quantiser (IQ) input 221 of an inverse quantiser device (IQ) 22. The IQ 22 is connected with an IQ output 222 to an input 251of an inverse discrete cosine transformer device (IDCT) 25. The IDCT 25 is attached to a first combiner input 151′ of a second combiner device 15′ via an IDCT output 252. The second combiner device 15′ is also connected with a second combiner input 153′ to a predictor output 132 of the predictor device 13. An output 152′ of the second combiner device 15 is connected to a second input 133 of the predictor device 13. A second predictor output 139 of the predictor device 13 is connected to a first evaluator input 1601 of an evaluator device 16 which is also connected to the combiner output 152 of the first combiner device via a second evaluator input 1603. An evaluator output 1602 is connected to a switch control input 183 of the switch 18 and a skip control input 233 of the skip device 23.

In use, signals representing images may be received at the MPEG-2 encoder input 11. The received images are stored in the memory device 12 and transmitted to both the predictor device 13 and the first combiner device 15. The predictor device may predict B-frames, so in the memory 12, the order of the received images may be rearranged to allow the prediction.

The predictor device 13 predicts an image, based on preceding and/or succeeding images. The first combiner device 15 combines the predicted image with an original image stored in the memory 12. This combination results in residual data containing information about differences between the predicted image and the original image. The residual data is transmitted by the first combiner device 15 to the evaluator device 16 and the switch device 18.

In a connected state the switch input and the switch output are communicatively connected to each other. In a disconnected state, the switch input and the switch output are communicatively disconnected. The state of the switch is controlled by a signal presented at the switch control input 183. In the example of FIG. 3, the evaluator device controls the state of the switch 18. In the connected state, the switch device transmits the residual data to the DCT device 20. In should be noted that the switch 18 may be omitted, in the shown example, the switch 18 is implemented in the encoder to avoid useless processing of residual data may be discarded by the skip device 23.

The DCT 20 may convert the residual data signals from the spatial domain into the frequency domain using discrete cosine transforms (DCTs). Frequency domain transform coefficients resulting from the conversion into the frequency domain are provided to the quantiser device 21.

The quantiser device 21 quantises the transform coefficients to reduce the number of bits used to represent the transform coefficients and transmits the resulting quantised data to the skip device 23.

The skip device 23 decides may insert a skip macro-block escape code or a coded-block pattern escape code as is defined in the MPEG-2 standard, depending on the signal presented at the skip control input 233.

The variable-length coder 24 subjects the quantised transform coefficients from the quantiser 21 (with any inserted skip code) to variable-length coding, such as Huffmann coding and run-length coding. The resulting coded transform coefficients, along with motion vectors from the predictor 13, are then fed as a bit stream, via the output buffer 19, to a digital transmission medium, such as a Digital Versatile Disk, a computer hard disk or a (wireless) data transmission connection.

The predictor device comprises 13 two memories 134,135 (MEM fw/bw and MEM bw/fw) which are connected to the second predictor input 133 with a respective memory input 1341,1351. The memories 134,135 contain a previous I- or P-frame and a next P-frame. The frames in the memories are transmitted to a motion estimator device (ME) 136 and a motion-compensated predictor device (MC) 138, which are connected with their inputs 1361,1381 to outputs 1342,1352 of the memories. Of course, the memories 134,135 may likewise be implemented as a single memory device stored with data representing both frames.

The ME 136 may estimate motion-vector fields and transmit the estimated vectors to a vector memory (MEM MV) 137 connected with an input 1371 to a ME output 1362. The motion estimation (ME) may be based on the frames stored in the memories 134,135 or on the frames in the shuffling memory 12. The vectors stored in the MEM MV 137 are supplied to a motion compensated predictor 138 and used in a motion compensated prediction. The result of the motion compensated prediction is transmitted to the first predictor output 132.

The vectors stored in the MEM MV 137 are also transmitted to the second output 139 of the predictor device 13. The vectors are received via the first estimator input 1601 by a vector inconsistency estimator 162 in the evaluator device 16. The vector inconsistency estimator performs an operation described by equation (4) or equation (7) for the vectors from the vector memory 137.

A second evaluator input 1602 connects a SAD device 161 to the combiner output 152 of the first combiner device 15. The SAD device 161 determines the SAD as described by equation 2′ from the residual data at the output of the first combiner device 15. Both the SAD and the vector inconsistency are thresholded by the respective devices. The result of the thresholding is fed into an AND device 163, which performs an AND operation as is described above. The output signal of the AND device 163 is fed to the control inputs of the switch device 18 and the skip device 23.

Thus, the combined values of the SAD and vector inconsistency result in a binary decision (error criterion) per macro-block whether to transmit the residual data or not and whether to insert a macro-block skip code or not. The magnitude and direction of the estimated motion vectors may locally deviate from the true motion. In the case of a small local deviation of the motion vectors, the local value of R depends on the local level of high-frequent detail. In the case of high level local detail, the high numerical value of R suggests that it is necessary to locally ‘repair’ the erroneous estimate. However, in case a motion vector deviation extends over a large area, and in case the direction and magnitude of the deviation is consistent within that area, small deviations are not perceived.

The binary decision is used to avoid further calculation of the DCT and results in the generation of the skip macro-blocks escape code (skip MBs) and coded-block pattern escape codes to skip empty DCT-blocks within one macro-block. The use of the skip macro-blocks and coded-block pattern escape code results in an efficient description of residual frame data With the new criterion, the encoder still produces an MPEG-2 bitstream which can be decoded by every MPEG-2-compliant decoder. The binary decision is used to avoid further calculation of the DCI and results in the generation of the skip macro-blocks escape code (skip MBs) and coded-block pattern escape codes to skip empty DCT-blocks within one macro-block.

Both the MPEG-2 bitstream and the proprietary residual stream are multiplexed to form one MPEG-compliant stream. The MPEG-2 standard supplies the possibility to use a so called private data channel for proprietary data. In case no residual data is transmitted only the Boolean map S_{perceived}(x,y,t) is transmitted. The use of the skip macro-blocks and coded-block pattern escape codes enables us to avoid a separate transmission of the Boolean map S_{perceived}(x,y,t). The pattern of the escape codes within each frame implicitly holds the information to regenerate the Boolean S_{perceived}(x,y,t).

The motion estimator may be of any type suitable for the specific implementation. In video coding, most methods for motion estimation are based on full-search block matching (FSBM) schemes or efficient derivations thereof. The motion estimation may also be based on a estimation method known from frame-rate conversion method. In such methods frames are temporally interpolated using previous and future frames, similar to video compression. However, since no residual data is available, the correct motion vector field for frame-rate conversion almost always represents the true motion of the objects within the image plane. The method of three-dimensional recursive search (3DRS) is the probably the most efficient implementation of true-motion estimation which is suitable for consumer applications [3,4,5,6,7]. The motion-vectors estimated using 3DRS tend to be equal to the true motion, and the motion-vector field inhibits a high degree of spatial and temporal consistency. Thus, the vector inconsistency is low, which results in a high threshold to the SAD values. Since the SAD-values are not thresholded very often, the amount of residual data transmitted is reduced compared to the non-true motion estimations.

The invention may be applied in various devices, for example a data transmission device 40 as shown in FIG. 8, like a radio transmitter or a computer network router that includes input signal receiver means 41 and transmitter means 42 for transmitting a coded signal, such as an antenna or an optical fibre. The data transmission device 40 is provided with the image encoder device 10 according to an embodiment of the invention that is connected to the input signal receiver means 41 and the transmitter means 44. Such a device is able to transmit a large amount of data using a small bandwidth since the data is compressed by the encoding process without perceived loss of image quality.

It is equally possible to apply the image encoder device 10 in a data storage device 30 as in FIG. 9, like an optical disk writer, for storing images on a data container device 31, like a SACD, a DVD, a compact disc or a computer hard-drive. Such a device 30 may include holder means 32 for the data container device 31, writer means 33 for writing data to the data container device 31, input signal receiver means 34, for example a microphone and a prediction coder device 1 according to the invention that is connected to the input signal receiver means 34 and the writer means 33, as is shown in FIG. 10. This data storage device 30 is able to store more data, i.e. images or video on a data container device 31, without perceived loss of image or video quality.

Similarly, an audio-visual recorder device 60, as shown in FIG. 10, comprising audiovisual input means 61, like a camera or a television cable, and data output means 62 may be provided with the image encoder device 10 thereby allowing to record more images or video data while using the same amount of data storage space.

Furthermore, the invention can be applied to data being stored to a data container device like a floppy disk a Digital Versatile Disc or a Super Audio CD, or a master or stamper for manufacturing DVDs or SACDs.

The invention may also be implemented in a computer program for running on a computer system, at least including code portions for performing steps of a method according to the invention when run on a computer system or enabling a general propose computer system to perform functions of a computer system according to the invention. Such a computer program may be provided on a data carrier, such as a CD-rom or diskette, stored with data loadable in a memory of a computer system, the data representing the computer program. A data carrier may further be a data connection, such as a telephone cable or a wireless connection transmitting signals representing a computer program according to the invention.

In the foregoing specification, the invention has been described with reference to specific examples of embodiments of the invention. The specifications and drawings are, accordingly, to be regarded in an illustrative rather than in a restrictive sense. It will, however, be evident that various modifications and changes may be made thereunto without departing from the broader spirit and scope of the invention as set forth in the appended claims.

For example, the invention is not limited to implementation in the disclosed 5 examples of devices, but can likewise be applied in other devices. In particular, the invention is not limited to physical devices but can also be applied in logical devices of a more abstract kind or in a computer program which enables a computer to perform functions of a device according to the invention when run on the computer.

Furthermore, the devices may be physically distributed over a number of apparatuses, while logically regarded as a single device. Also, devices logically regarded as separate devices may be integrated in a single physical device having the functionality of the separate devices.

References

[1] D. L. Gall, “MPEG: A video compression standard for multimedia applications,” Communications of the ACM, vol. 34, no. 4, pp. 46-58, 1991.
[2] J. L. Mitchell, W. B. Pennebaker, C. E. Fogg, and D. J. LeGall, MPEG Video Compression Standard. Digital Multimedia Standards Series, New York, N.Y.: Chapman & Hall, 1997.
[3] G. de Haan and H. Huijgen, “Method of estimating motion in a picture signal.” U.S. Pat. No. 5,072,293, December 1991.
[4] G. de Haan and H. Huijgen, “Motion vector processing device.” U.S. Pat. No. 5,148,269, September 1992.
[5] G. de Haan and H. Huijgen, “Apparatus for motion vector estimation with asymmetric update region.” U.S. Pat. No. 5,212,548, May 1993.
[6] G. de Haan, P. W. A. C. Biezen, H. Huijgen, and O. A. Ojo, “True-motion estimation with 3-D recursive search block matching,” IEEE transactions on Circuits and Systems for Video Technology, vol. 3, pp. 368-379, October 1993.
[7] G. de Haan and P. W. A. C. Biezen, “Sub-pixel motion estimation with 3-D recursive search blockmatching,” Signal Processing: Image Communication, vol. 6, pp. 229-239, 1994.
[8] U.S. Pat. No. 5,057,921.

1. An image encoder (10;100), at least comprising:
at least one encoder input (11);
at least one memory device (12,121-123) connected to said encoder input, for storing at least one image received at said input;
at least one image predictor device (13,131-139) for predicting a prediction image based on at least one first image stored in said memory device;
a combiner device (15,151-153) for determining residual data relating to a difference between an original image and the prediction image;
a first evaluator device (161,1611-1613) for determining at least one first characteristic;
an inhibiter device (18,181-183; 23,231-233) connected to said combiner device and said first evaluator device, for transmitting said residual data further if said first characteristic checks against said first predetermined criterion; and
at least one encoder output (19) connected to said inhibiter device,
characterized in that:
said image encoder (10;100) further comprises:
a second evaluator device (162,1621-1622) for determining at least one second characteristic, and
said inhibiter device (18,181-183; 23,231-233) is arranged for transmitting said residual data further depending on said first characteristic and said second characteristic.

2. An image encoder (10;100) as claimed in claim 1, wherein
said first evaluator device (161,1611-1613) is arranged for determining at least one first characteristic relating to said difference and
a second evaluator device (162,1621-1622) for determining at least one second characteristic corresponding to changes of elements in said original image compared to said at least one first image.

3. An image encoder (10;100) as claimed in claim 1, wherein
said first evaluator device (161,1611-1613) is arranged for checking said first characteristic against a first criterion,
said second evaluator device (162,1621-1622) is arranged for checking said second characteristic against a second criterion and
said inhibiter device is arranged for transmitting said residual data further if said first characteristic checks against said first criterion and said second characteristic checks against said second criterion.

4. An image encoder (10;100) as claimed in claim 3, wherein
said first evaluator device (161) comprises:
an average device for determining an average prediction error a first comparator device for comparing said average prediction error with an error threshold value.

5. An image encoder as claimed in claim 3, wherein said image predictor device comprises:
at least one motion vector estimator device (136, 1361-1363), for predicting motion vectors relating to position changes of elements in said image; and
said second evaluator device (162)comprises:
a motion vector inconsistency estimator and
a second comparator device for comparing said motion vector inconsistency value with a predetermined inconsistency threshold value.

6. An image encoder (10;100) as claimed in claim 5, wherein said motion vector inconsistency estimator device is arranged for performing an operation represented by the mathematical algorithm:
$$VI ( x , y , t ) = \frac{1}{( 2 N + 1 ) ( 2 M + 1 ) ( P + 1 )}$$
$${\sum }_{ξ = 1}^{N} {\sum }_{γ = 1}^{M} {\sum }_{τ}^{P} \vert \vec{D} ( x , y , t ) - \vec{D} ( x + ξ , y + γ , t - τ ) \vert$$
wherein VI represents said vector inconsistency, \vec{D} represents a motion vector, N represents a horizontal dimension of a area of evaluation of said prediction image, M represents a vertical dimension of said spatial area, P represents is a number of previous vector fields.

7. An image encoder (10;100) as claimed in claim 5, wherein said motion vector inconsistency estimator device is arranged for performing an operation represented by the mathematical algorithm:
$$VI ( x , y , t ) = {max}_{- N \leq ξ \leq N ⋀ - M \leq γ \leq M ⋀ 0 \leq r \leq P} \\ \vert \vec{D} ( x , y , t ) - \vec{D} ( x + ξ , y + γ , t - τ ) \vert$$
wherein VI represents said vector inconsistency, \vec{D} represents a motion vector, N represents a horizontal dimension of a area of evaluation of said prediction image, M represents a vertical dimension of said spatial area, P represents is a number of previous vector fields.

8. An image encoder (10;100) as claimed in claim 5, wherein said second comparator is arranged for performing an operation represented by the mathematical algorithm:
$${S}_{VI} ( x , y , t ) = \{ \begin{matrix}1 & VI ( x , y , t ) > {T}_{VI} \\ 0 & otherwise\end{matrix} .$$
where S_{VI} represents a binary value indicating the outcome of said checking, and T_{VI} represents said predetermined threshold value.

9. An image encoder (10;100) as claimed in claim 1, wherein said prediction image is an interpolated image, predicted from at least one preceding image preceding said original image and at least one succeeding image succeeding said original image.

10. An image encoder (10;100) as claimed in claim 9, wherein said interpolated image is an MPEG B-frame image.

11. An image encoder (10;100) as claimed in claim 5, wherein said motion estimator device (136,1361-1363) is a true motion estimator device.

12. An image encoder (10;100) as claimed in claim 3, wherein the first criterion is related to the second characteristic

13. An image encoder as claimed in claim 12, wherein the vector inconsistency is used to compute said first threshold according to the mathematical algorithm: T_{MAD(x,y,t)}=α(VIₘₐₓ−VI(x,y,t)) with a positive multiplication factor, and VIₘₐₓ=2|\vec{D}|ₘₐₓ being the maximum of possible VI-values.

14. An MPEG compliant image encoder (100), comprising at least one image encoder as claimed in claim 1.

15. A coding method, comprising:
receiving (I) at least one first image and an original image;
predicting (IV) a prediction image based on said at least one first image;
determining (V) residual data relating to a difference between the original image and the prediction image;
and transmitting(VIII) said residual data further if at least one predetermined criterion is satisfied,
characterized in that:
said at least one criterion comprises:
determining (V) at least one first characteristic; and
determining (III, VI) at least one second characteristic.

16. A data transmission device (40) comprising input signal receiver means (41), transmitter means (42) for transmitting a coded signal and an image encoder device (10) as claimed in claim 1 connected to the input signal receiver means and the transmitter means.

17. A data storage device (30) for storing data on a data container device (31), comprising holder means (32)for said data container device, writer means (33) for writing data to the data container device, input signal receiver means (34) and an image encoder device (10) as claimed in claim 1 connected to the input signal receiver means and the writer means.

18. An audiovisual recorder device (60), comprising audiovisual input (61) means, data output means (62) and an image encoder device (10) as claimed in claim 1.

19. A coding system, comprising:
an encoder device
a decoder device communicatively connected to said encoder device,
characterized in that
said encoder device comprises at least one inverse an image encoder device as claimed in claim 1.

20. A data container device containing data representing images coded with a image encoder device as claimed in claim 1.

21. A computer program including code portions for performing steps of a method as claimed in claim 15.

22. A data carrier device including data representing a computer program as claimed in claim 21.

23. A signal stream representing encoded images, said stream including
data representing at least one predicted image and
said stream containing
residual data relating to a difference between said predicted image and an original image depending on a first characteristic and a second characteristic of if
at least one first value corresponding to said difference checks against a first criterion and
at least one second value corresponding to a predicted change of elements in said predicted image checks against a second criterion.
